(19) United States
(12) Patent Application Publication
(10) Pub. No.: US 2026/0339678 A1
(43) Pub. Date: Oct. 29, 2026

(54) INFORMATION HANDLING SYSTEM CONFIGURATIONS FOR SPECIALIZED COMPUTE OR NETWORK ENVIRONMENTS

(71) Applicant: DELL PRODUCTS L.P., Round Rock, TX (US)

(72) Inventor: Claudio DESANTI, Santa Cruz, CA (US)

(73) Assignee: DELL PRODUCTS L.P., Round Rock, TX (US)

(21) Appl. No.: 19/193,960

(22) Filed: Apr. 29, 2025

(51) Int. Cl. G06F 9/445

(52) U.S. Cl. CPC G06F 9/44505

(57) ABSTRACT

Presented herein are systems and methods related to information handling system configurations for specialized compute or network environments, such as artificial intelligence (AI)/machine learning (ML) deployments. Embodiments comprise networking information handling systems (e.g., switches) with an OSFP connector count/port count configured to correlate with the port count of the systems that are being interconnected by the switch(es). In one or more embodiments, the switching module may comprise a lower-than-maximum number of ports that the switching module could support but is better matched to its deployed use. In one or more embodiments, the networking information handling system may also include, in the front panel and/or in the back panel, one or more additional connectors or interfaces dedicated to specialized functions, such as SPAN or in-band management, by leveraging some of the unconnected switching module ports that were not used for data handling ports.

### BACKGROUND

### A. Technical Field

The present disclosure relates generally to information handling systems. More particularly, the present disclosure relates to networking and networking fabrics.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The ever-increasing development and use of machine learning and artificial intelligence (ML/AI) applications had created a dramatic increase in demand for computing resources and processing resources. Graphics processing units, with their specially designed architectures, are particularly well suited for using in ML/AI applications—both training and inferencing. With increasingly complex ML/AI models, more and more processing systems are needed.

Thus, the exponentially growing complexity of ML/AI models and their ever-growing voracious need for data have created needs for data centers with vast numbers of processing units and supporting infrastructure. The supporting infrastructure, including information handling systems, such as network switches, and cabling, have also become more complex and more closely tied to the ML/AI deployment. For example, in addition to needing large numbers of complex processing information handling systems, aspects such as physical placement, type of cabling, and network topology should be considered. Because of the staggering number of computation operations that are involved in most modern ML/AI applications, even a small fraction of a second delay in processing aggregates into a significant amount.

Accordingly, it is highly desirable to find new, better ways to build compute/data centers, particularly those used in high-computation environments, such as ML/AI applications.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts the front face of an example 128-radix Ethernet switch, according to embodiments of the present disclosure.

FIG. 2 depicts the front face of 144-radix InfiniBand switch proposed by NVIDIA Corporation, a multinational corporation headquartered in Santa Clara, California.

FIG. 3 depicts a railpod configuration built with 128-port switches (i.e., switches with radix of 128), according to embodiments of the present disclosure.

FIGS. 4 and 5 depict railpod configurations built with 144-port switches (i.e., switches with radix of 144).

FIG. 6 shows the maximum scale-out fabric using 128-port switches when using 12 Dell XE9680L rack-scale servers per rack, which comprises a total of 96 GPUs per rack and correspondingly has 92 ports per rack.

FIG. 7 shows the maximum scale-out fabric using 144-port switches when using 12 Dell XE9680L rack-scale servers per rack.

FIG. 8 shows the maximum scale-out fabric using 128-port switches when using Dell XE9712 (i.e., NVL72) racks that each have 72 GPUs per rack.

FIG. 9 shows the maximum scale-out fabric using 144-port switches when using Dell XE9712 (i.e., NVL72) racks that each have 72 GPUs per rack.

FIG. 10 graphically depicts switching application-specific integrated circuit (ASIC) configured for specialized or specific deployments, according to embodiments of the present disclosure.

FIG. 11 depicts a front face of a networking information handling system, according to embodiments of the present disclosure.

FIG. 12 depicts an example methodology for forming a scale-out fabric, according to embodiments of the present disclosure.

FIG. 13 depicts an example NVL72 system from NVIDIA Corporation, a multinational corporation headquartered in Santa Clara, California.

FIGS. 14-17 graphically depict different example racking configurations using NVIDIA Q3400 switches versus corresponding example racking configuration using embodiments discussed herein, according to embodiments of the present disclosure.

FIG. 18 depicts a simplified block diagram of an information handling system, according to embodiments of the present disclosure.

FIG. 19 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

Any embodiment or embodiments described herein are not necessarily limited strictly to the features expressly described for that specific embodiment and may also (or alternatively) include properties and/or features (e.g., ingredients, components, members, elements, parts, regions, property, and/or functions) described for one or more separate embodiments. Accordingly, the various features of a given embodiment or embodiments may be combined with and/or incorporated into another embodiment or embodiments. Disclosure of certain features relative to a specific embodiment or embodiments should not be construed as limiting application or inclusion of said features to the specific embodiment or embodiments. Rather, it will be appreciated that other embodiments may also include such features.

It shall also be noted that although embodiments described herein may be within the context of GPUs, AI/ML, and scale-out networks, aspects of the present disclosure are not so limited. Accordingly, the aspects of the present disclosure may be applied or adapted for use in other contexts.

### A. General Introduction

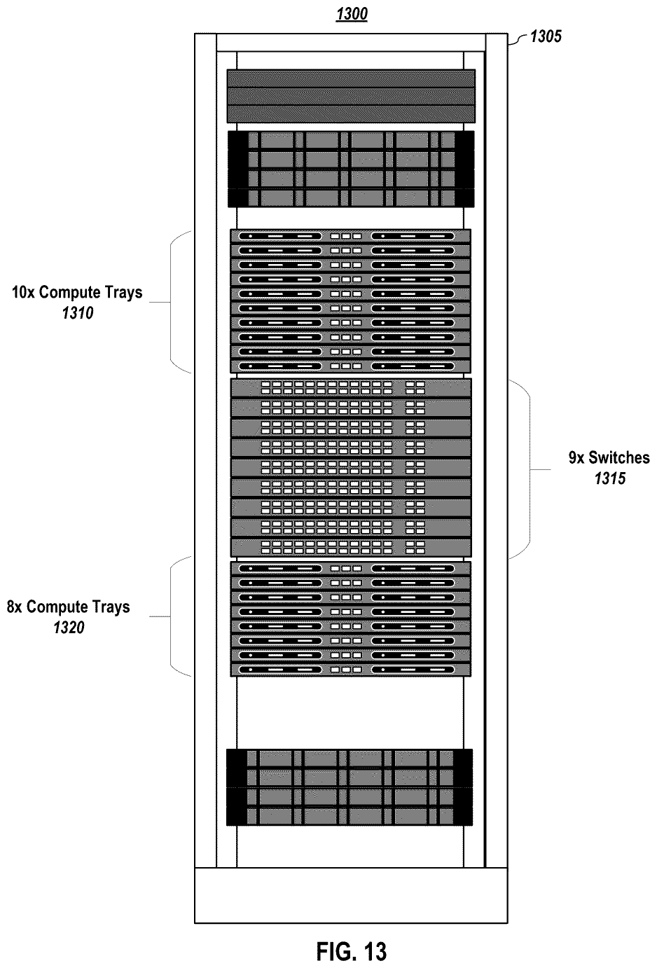

Multiple companies, particularly those wanting to develop and/or deploy ML/AI applications, desire high density rack-scale graphics processing unit (GPU) solutions. One such system is the NVL72 system from Nvidia Corporation, a multinational corporation headquartered in Santa Clara, California. The NVL72 system (see FIG. 13) typically comprises eighteen (18) compute sleds (or trays) and nine (9) switches for data traffic processing—all housed within a rack. The system may comprise additional elements, such as power supplies, cooling system(s), redundancy system(s), additional processing information handling system(s), among other elements common to a network or data center rack.

Each compute sled (tray or module) comprises four (4) GPUs and two Grace processors. Each Grace processor typically supports a BlueField-3 (BF3) data processing unit (DPU) to connect to a front-end fabric and two network interface cards (NICs), each coupled with one GPU, to connect to a scale-out fabric. The NIC used currently is a 400 Gb/s CX-7 NIC with plans to replace the CX-7 NICs with 800 Gb/s CX-8 NICs that will be also directly connected to the Blackwell GPUs. Each is also directly connected to an NVLink-based scale-up fabric for high-bandwidth parameter exchanges among GPUs within the rack.

GPUs represent high-performance accelerators designed primarily for artificial intelligence (AI), machine learning (ML), and high-performance computing (HPC) workloads. Such GPUs feature a significant performance boost in enhanced computational power, scalability, and energy efficiency. Some key features of the GPU include:
tensor cores optimized for AI workloads, enabling faster training and inference for deep learning models;
high-bandwidth, low-latency communication links, enabling efficient scaling across multiple GPUs;
a hopper architecture, which introduces support for advanced operations like sparsity, further accelerating AI computations; and
other supporting elements, such as L2 cache.

The GPU supports increased memory bandwidth and large memory capacity, allowing it to handle massive datasets and complex models. The PCIe interface(s) provide interfaces for a “scale-out” fabric to connect to other systems, and the links or connections provide interfaces for a “scale-up” fabric or connectivity within the NVL72 unit.

Dell recently introduced an industry-leading set of integrated rack systems, the Dell Integrated Rack Scalable Systems (IRSS). Dell's IRSS product line provides a comprehensive, turnkey solution for deploying fully integrated, plug-and-play, rack-scale systems. IRSS solutions are designed for rack-scale AI and HPC deployments, efficiently use space, energy efficiency, reducing costs, and may be delivered as fully built and tested sets of racks. Several IRSS variants are available from Dell. For examples, the Integrated Rack 7000 (IR7000) series is a next-generation infrastructure that reimagines data centers for the new era of high-density computing. Designed for scalability, sustainability, and advanced cooling technologies, the IR7000 series is well suited for large, rack-scale AI workloads with high core density and direct liquid cooling. As an Open Compute Project (OCP) Foundation standards-based infrastructure to rack, the IR7000 scales to support multigeneration and heterogeneous technology with diverse rack compute options.

Another IRSS offering is the Dell Integrated Rack 5000 (IR5000) series. The Dell Integrated Rack 5000 (IR 5000) is a standard 19-inch rack that currently delivers the highest available GPU density while ensuring energy efficiency through advanced thermal management. This rack offers both air and liquid cooling options, providing flexibility and scalability for AI infrastructures.

Of these various systems, there are two offerings of maximum numbers of GPUs or nodes (i.e., other compute units, such as AMD nodes). One set can support up to 72 GPUs or nodes per rack (e.g., PowerEdge M7725, PowerEdge XE9712, and PowerEdge XE9680L). While another set can support up to 96 GPUs or nodes per rack (e.g., PowerEdge XE9680L). The number of GPUs or nodes corresponds to the number of interfaces for the rack system.

It should be noted that whether 72 or 96, the prime number factorization of each of these numbers includes 3 as a factor (i.e., 72=2³×3² and 96=2⁵×3). However, the information handling systems (e.g., switches) are typically all just factors of only 2 (e.g., 64 ports or 128 ports). This mismatch between interfaces on the rack systems and the number of ports of switches raises the question: “Which switch is optimal to support these systems?”

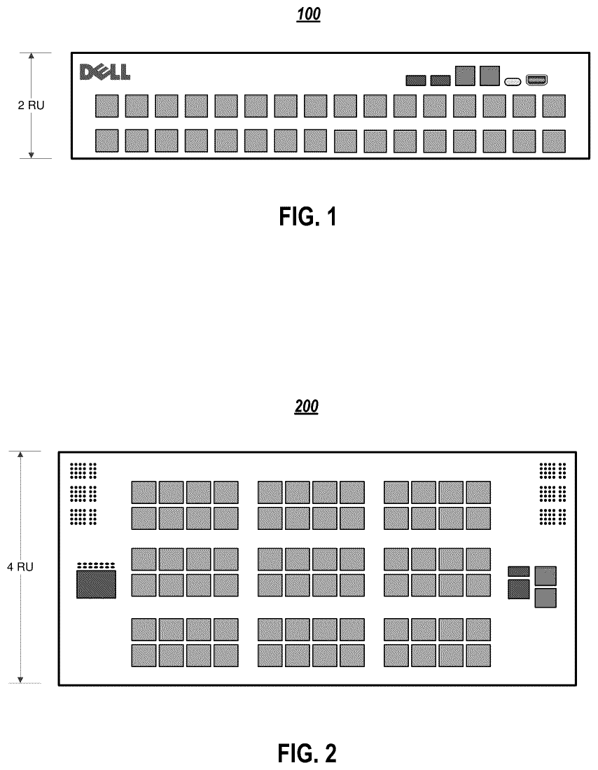

Consider two types of switches as shown in FIG. 1 and FIG. 2.

FIG. 1 represents a 128-port Ethernet switch, such as Dell Z9864F (or an NVIDIA SN5600), providing 128×400GE through 64 OSFP (Octal Small Form Factor Pluggable) connectors. These switches typically employ 100 gigabits/second (100 Gb/s) SerDes links. A SerDes (Serializer/Deserializer) link is an important component in high-speed communication systems, including networking switches. It converts data between serial and parallel formats, enabling efficient data transmission over limited input/output channels. Depending upon implementation, a number of these links may be combined to form a port. For example, four 100 Gb/s links may be used to form a 400 GE port. These switches have a radix of 128 and are typically two rack units (2 RUs) in height.

FIG. 2 represents a recently announced 144-port InfiniBand XDR (eXtended Data Rate) switch from NVIDIA of Santa Clara, California. This 144-port switch, known as the Q3400, provides 144 XDR ports over 72 OSFP connectors. This switch uses 200 Gb/s SerDes and may also provide an additional OSFP connector for in-band management functions. This switch has a radix of 144. To accommodate that 144 ports, including added cooling requirements, the switch has a form factor of 4 rack units (4 RU).

Coupling racks with a number of interfaces including the prime factor number 3 (e.g., 72=2³×3² or 96=2⁵×3) with a switch having a pure power of 2 (e.g., 128=2⁷) factorization number of switch ports lead to inefficiencies.

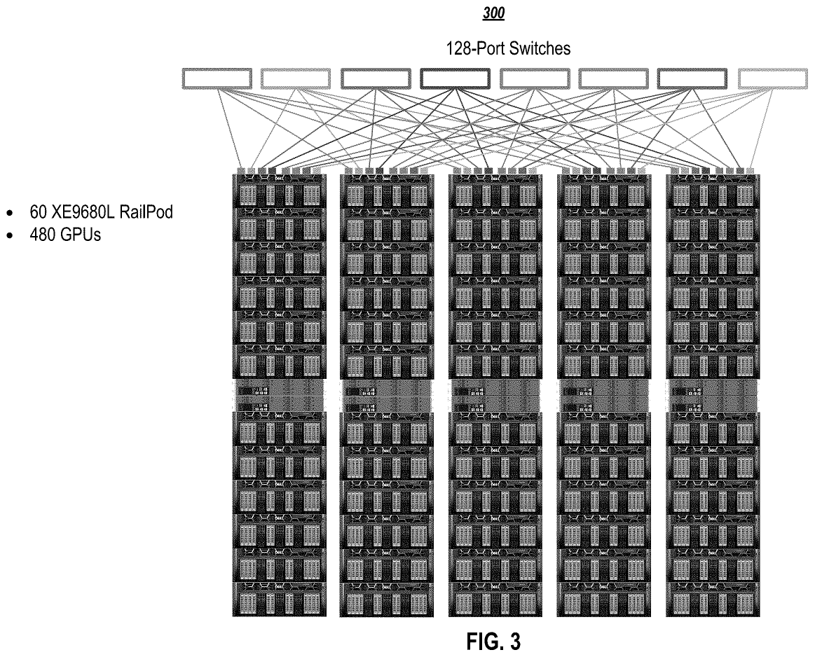

FIGS. 3-5 shows, in the context of AI/ML fabrics, the structure of some possible railpods using racks with 96 GPUs per rack (e.g., using the high-density XE9680L rack configuration which has 96 GPUs per rack). For 128-port switches, 64 ports may be used as downlinks and 64 ports as uplinks. For 144-port switches, 72 ports may be used as downlinks and 72 ports as uplinks (i.e., no oversubscription).

FIG. 3 depicts a railpod configuration built with 128-port switches (i.e., switches with radix of 128), according to embodiments of the present disclosure. As shown, using 128-port switches enables building a 480-GPU railpod comprising five racks, in which each switch has four downlinks not used.

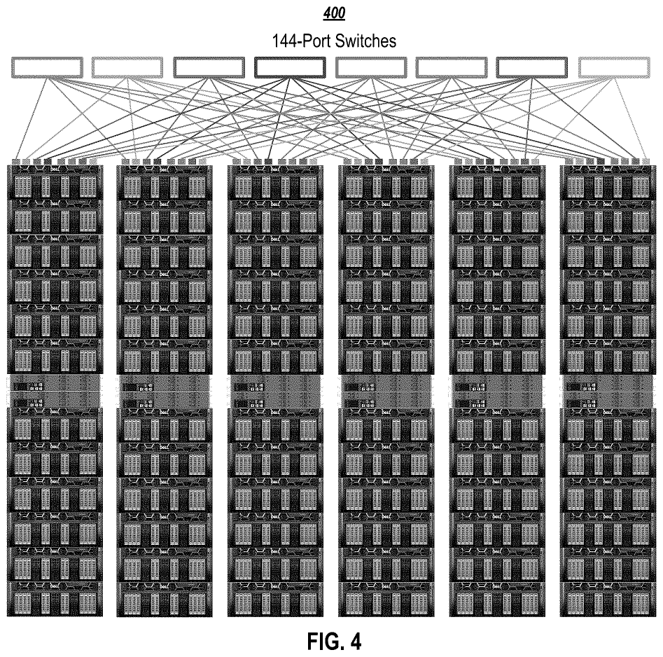

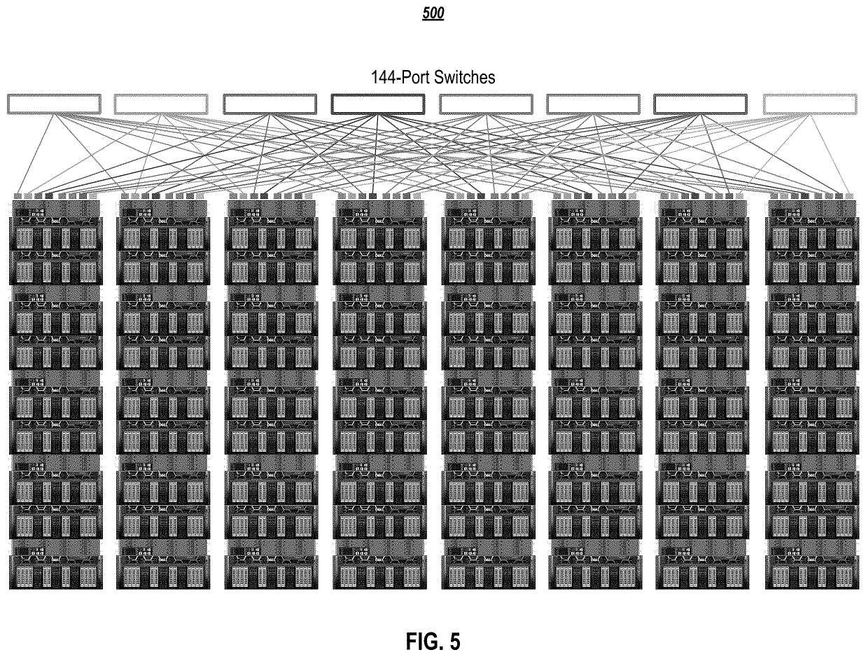

FIGS. 4 and 5 depict railpod configurations built with 144-port switches (i.e., switches with radix of 144), according to embodiments of the present disclosure. Using 144-port switches enables building a 576-GPU railpod, using six racks with 96 GPUs per rack or using eight racks with 72 GPUs per rack, in which each switch fully utilizes the 72 downlinks.

The inefficiencies associated with 128-port switches when used with racks having 72 or 96 interfaces/ports per rack become much more noticeable at larger scales.

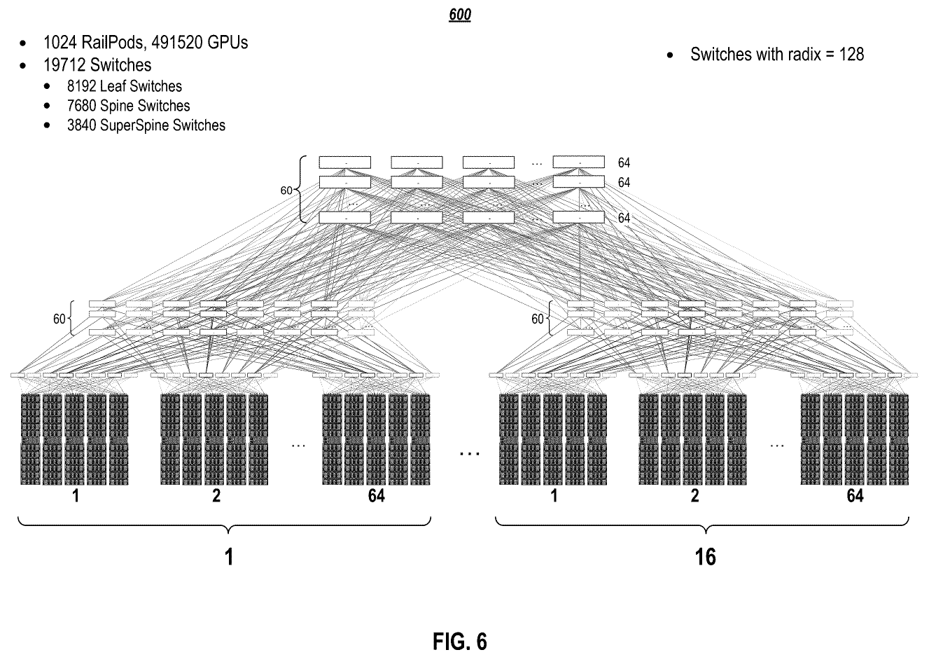

FIG. 6 shows the maximum scale-out fabric using 128-port switches when using 12 Dell XE9680L rack-scale servers per rack, which comprises a total of 96 GPUs per rack and correspondingly has 92 ports. This scale-out fabric can support 491520 (i.e., 480K, where K=1024 (power of 2)) GPUs.

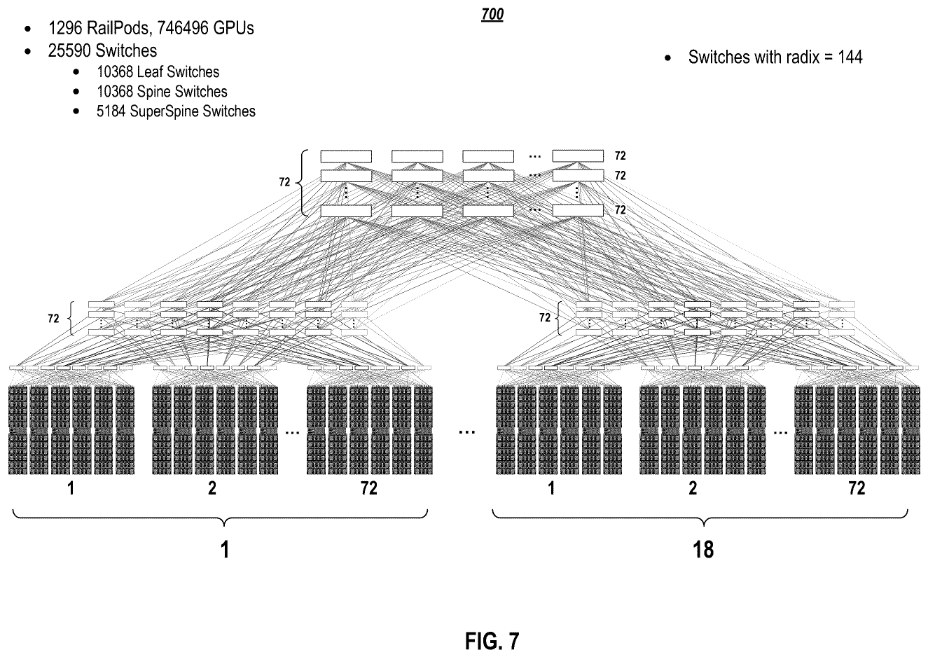

FIG. 7 shows the maximum scale-out fabric using 144-port switches when using 12 Dell XE9680L rack-scale servers per rack. This scale-out fabric can support 746496 (i.e., 729K) GPUs.

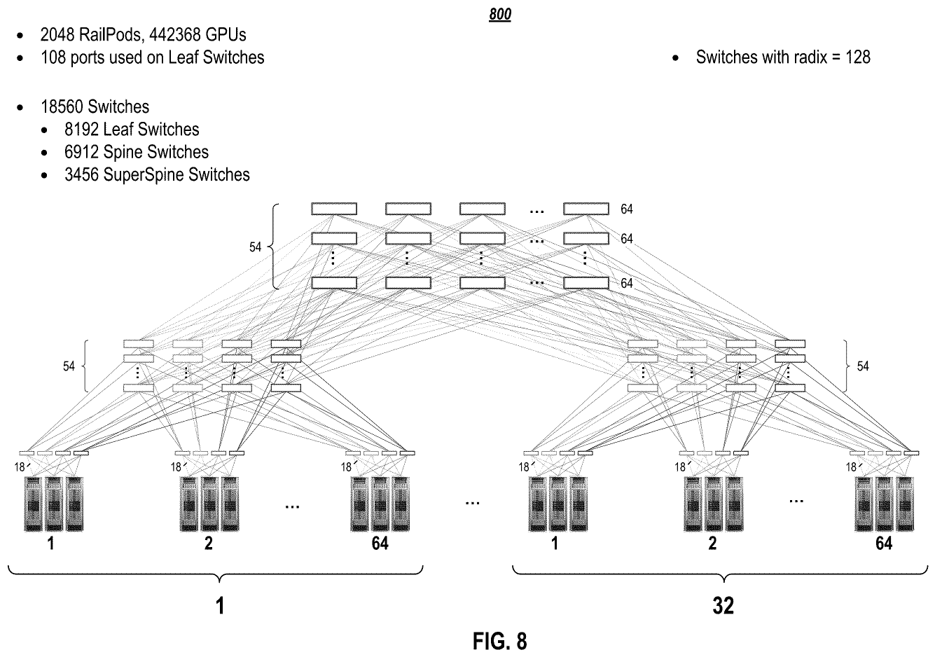

FIG. 8 shows the maximum scale-out fabric using 128-port switches when using Dell XE9712 (i.e., NVL72) racks that each have 72 GPUs per rack. Given the 72 GPUs per rack, a corresponding 72 ports are employed. The scale-out fabric employs four network rails. This scale-out fabric can support 442368 (i.e., 432K) GPUs.

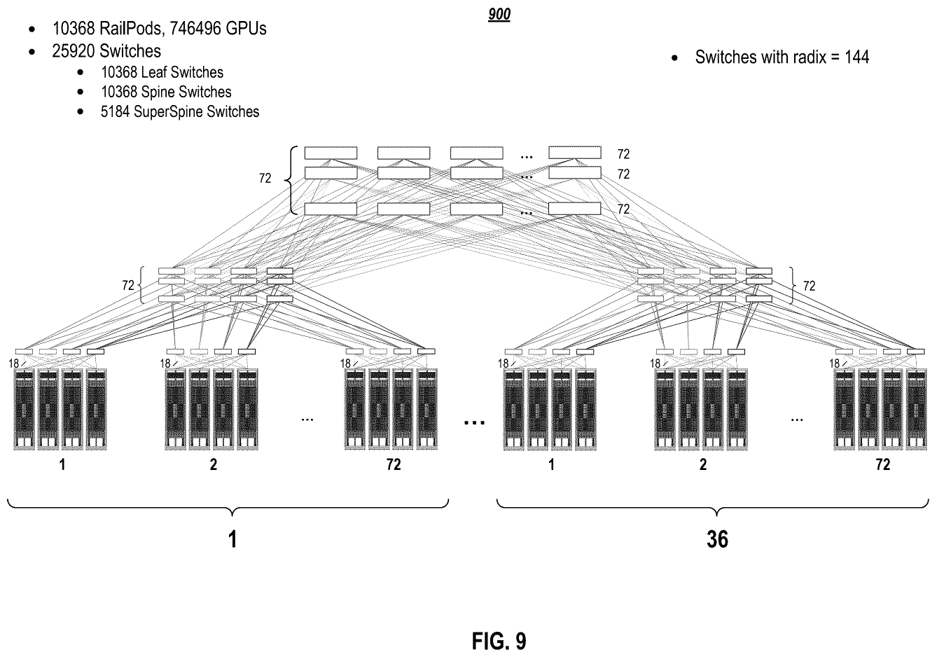

FIG. 9 shows the maximum scale-out fabric using 144-port switches when using Dell XE9712 (i.e., NVL72) racks that each have 72 GPUs per rack. Given the 72 GPUs per rack, a corresponding 72 ports are employed. The scale-out fabric employs four network rails. This scale-out fabric can support 746496 (i.e., 729K) GPUs.

By way of comparison, with a 128-port switch, the maximum scale-out fabric scales to less than half a million GPUs, but with a 144-port switch, the maximum scale-out fabric scales to 729K GPUs.

The above discussion shows that a radix 144 switch is preferred for many of the rack components like Dell IRSS that has a number of ports with a factorization that does readily correspond with the factorization of the number of ports supported by a networking information handling system (e.g., a switch) with a radix of 64 or 128. While NVIDIA has announced that it is going to offer a switch, named the NVIDIA Q3400, with a radix of 144, this switch is planned to be an InfiniBand switch. While InfiniBand is a high-performance computing interconnect standard designed for very high throughput and low latency, the industry in general prefers using Ethernet for networking. However, Ethernet switching ASICs (application-specific integrated circuits) come with a radix which is a power of 2 (e.g., 64, 128, etc.). For example, Broadcom Inc. of Palo Alto, California, offers the following type of switching units: the Broadcom Tomahawk-4,which is a 64×400GE switching ASIC; the Broadcom Tomahawk-5, which is a 128×400GE switching ASIC; and the Broadcom Tomahawk-6, which is planned to be a 256×400GE switching ASIC.

A switching ASIC like the Broadcom Tomahawk is a complex piece of hardware designed for high-performance networking. Some key components of switching ASICs include:

Packet Processing Engine: This is a core of the ASIC, responsible for handling and forwarding packets based on various protocols and rules.

Memory: Includes various types of memory (such as SRAM (Static RAM) and DRAM (Dynamic RAM)) for storing packet data, routing tables, and other critical information;

SerDes (Serializer/Deserializer): Converts data between serial and parallel formats, enabling high-speed data transmission over network interfaces;

MAC (Media Access Control) Layer: Manages data transmission and reception over the physical network layer, ensuring proper communication between devices;

TCAM (Ternary Content Addressable Memory): Used for fast lookups of routing and access control lists, allowing quick decision-making for packet forwarding;

QoS (Quality of Service) Engine: Ensures that network traffic is prioritized and managed according to predefined policies, improving overall network performance;

Switch Fabric: An internal network that connects various components within the ASIC, facilitating efficient data transfer; and

Control Plane Processor: Manages the overall operation of the ASIC, including configuration, monitoring, and management tasks.

The switching ASIC may be integrated into a switching module (e.g., a network information handling system). The switching module or information handling system may comprise a number of additional components, such as power, cooling, interfaces for various functions, etc. Examples of information handling systems and components (any of which may be included in an information handling system) are described in Section C, below.

Note that the factorization of all of these switching units by Broadcom is purely a power of 2.

Accordingly, it would be beneficial to have networking information handling systems (e.g., switches) that have a radix that corresponds to the radix of the compute systems that the networking information handling systems interconnect.

### B. Embodiments of Networking Information Handling Systems for Specialized Compute and Networking Environments

The current Ethernet switches connect all their switching ASICs ports to the front panel connectors for data ports to use the ASICs at their maximum capability. Embodiments herein address a different concern. Rather than trying to maximize the number of data ports that a switching ASIC can provide, embodiments herein intended for specialized products intended to have the number of data ports correlated (e.g., correlated by having a factorization that correlates with the systems they support). For example, currently, AI/ML deployments utilize configured systems with 72 or 96 GPUs (and corresponding number of data ports), which presents a mismatch with switches with radix of 64 or 128. By providing networking information handling systems with factors that evenly correspond with these systems (e.g., factorizations that include 2 and 3 rather than just 2), more efficient fabrics can be employed.

As noted above, Broadcom has a new switching unit forthcoming. The upcoming Broadcom Tomahawk-6 ASIC, with 256×400GE ports, will be available in two variants: TH6-100, using 100 Gb/s SerDes (1024 links total); and TH6-200, using 200 Gb/s SerDes (512 links total).

For purposes of illustration only, reference are made herein to Broadcom ASICs such as the Tomahawk-6 switch ASIC. However, it shall be noted that use of Broadcom ASICs is not exclusive (i.e., any other switching ASIC may be used, including but not limited to the NVIDIA Spectrum-6 or to ASICs not yet on the market).

In one or more embodiments, switching modules may be formed using switching ASICs in which maximizing the number of ports supported by the switching module is not the driving consideration. Rather, the number of ports supported by the switching module is related to its intended use—pairing it with the number of ports of the systems intended to be interconnected using the switching module. As noted above, in one or more embodiments, the pairing or correlation may be based upon the factorization of the number of ports so that fully utilization of the switch module's ports may be accomplished. Another aspect of the present disclosure is that existing switching ASICs may be leveraged or even salvaged to accomplish such results.

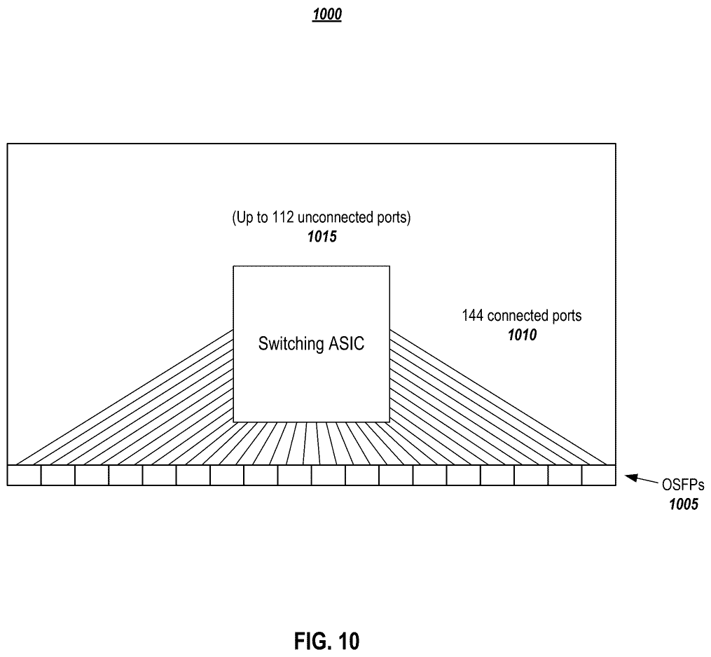

For example, a 144×400GE switch (i.e., a networking information handling system) may leverage the TH6-100 ASIC by having it form only 144 ports 1010 out of the maximum 256 ports to the front panel connector cages 1005, as shown in FIG. 10.

Building such a switching unit has several benefits. For example, it can be readily adapted from existing switching ASIC designs. Second, it can help improve the yield for such switching ASICs. Currently, the complexity of such switching ASICs means that a significant number of switching ASICs are unusable because not all of the links that are used to form the ports are fully operational. However, since a significant number of the links used to form ports are not needed, some manufactured ASICs that would previously have been discarded may be used for switching embodiments discussed herein. Third, since not all of the ports are used, the amount of power needed for the ASIC is reduced. Fourth, related to the prior point, with less power consumption comes less generated heat. Since the switching module will generate less heat, it can be housed in a smaller form factor. This smaller form factor results in dense usage in a rack or other deployments. For example, a networking information handling system with 144 ports may be configured to have a 2-RU form factor (instead of a typical 4-RU form factor that most switches of this type would be), because the OSFP connector traditionally has been specifically designed to allow for 36 connectors per RU. In one or more embodiments, only the ASIC ports closer to the front panel may be connected to the OSFP connector cages, simplifying the signal integrity for the platform. Fifth, as noted previously, by better matching the radix of the switch with the radix of the networked devices, more efficient network fabrics can be created.

In one or more embodiments, a few of the unconnected ports may be connected to some connector cages in the front, in the back, or both of the networking information handling system for some specialized functions.

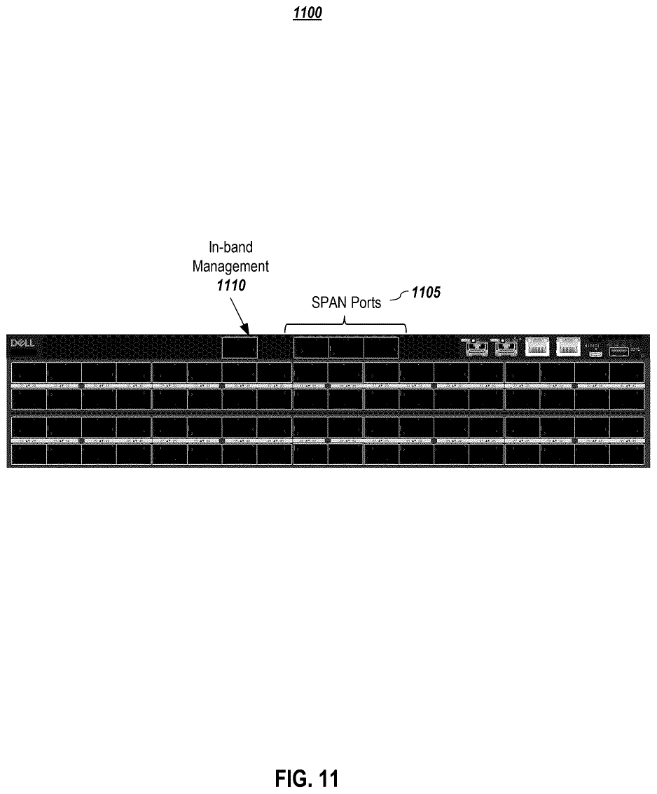

For example, the Broadcom TH6 supports up to three SPAN ports (Switch Port Analyzer, which is a feature used in networking to monitor network traffic to ensure network health and security). These ports may be used to mirror traffic—a very useful function for troubleshooting network problems. Normally, some ports of a switch need to be removed from normal operation (i.e., data traffic handling) and used for this function. A switch module of the present disclosure may have a number of non-data-handling ports (e.g., three additional OSFP connectors) just dedicated to the SPAN function 1105, as shown in FIG. 11. Such configurations simplify the use of the SPAN function in the large networks where this switch is expected to be used.

In one or more embodiments, another connector or connectors 1110 may be added to perform other non-data-handling functions, such as in-band management functions or other useful operations.

Such switching information handling systems are both revolutionary and evolutionary designs of our current switch offerings. For example, much of Dell's current Z9864 product can be leveraged for an embodiment of the current patent document that offers 144 ports. The new 144-port switch can keep the same form factor (2 RUs) and air cooling—rather than having to be a 4-RU design and/or require liquid cooling.

Any embodiment of such a switch (an 144-port, 2RU Ethernet switch) would fit perfectly for use in Ethernet-based AI fabrics built with the upcoming NVIDIA CX-8 Super-NIC. The CX-8 SuperNIC can operate as 1 XDR (eXtreme Data Rate) InfiniBand (IB) port, to connect with the Q3400 IB switch manufactured by NVIDIA, or as 2×400GE ports. The XDR IB port uses four serial links at 200 Gb/s, while each of the 400GE ports uses four links at 100 Gb/s. An embodiment of the present disclosure with 144 ports may be used to seamlessly map every scalable unit (i.e., a fundamental building block built for compute architecture or deployment) for InfiniBand XDR with the Q3400 to 400Gb Ethernet using the embodiment switches. Furthermore, given that the Q3400 is a 4-RU switch, while an embodiment of the present disclosure may be a 2-RU switch, such deployments can have additional rack space advantages.

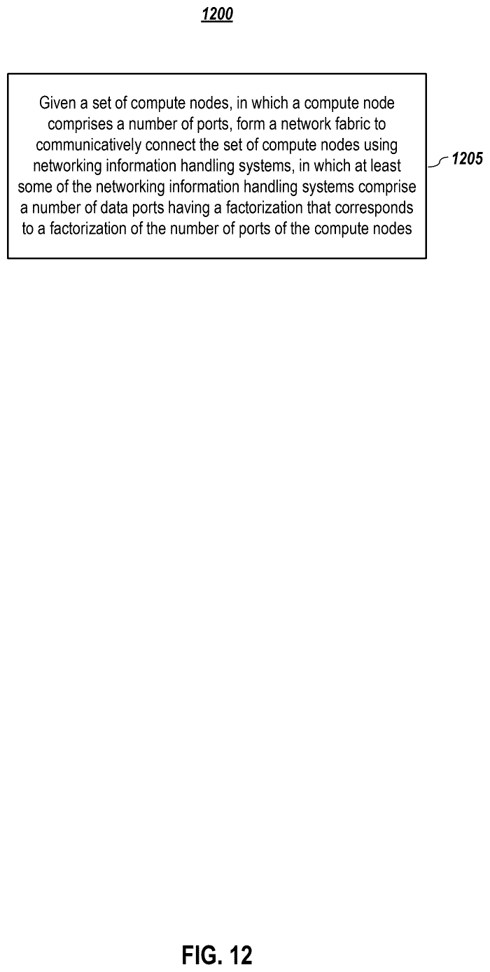

FIG. 12 depicts an example methodology for forming a scale-out fabric, according to embodiments of the present disclosure. Given a set of compute nodes (e.g., AI compute trays or sleds), in which a compute node comprises a number of ports, a network fabric (e.g., a scale-out fabric) may be formed (1205) by communicatively connecting the set of compute nodes using networking information handling systems that comprise a switching module configured to have a number of data ports with a factorization that corresponds to a factorization of the number of ports of the compute nodes.

In one or more embodiments, if the networking information handling system includes one or more additional ports (i.e., non-data-ports), the method may also include forming a communicative connection via at least one of the one or more additional interfaces for a management, troubleshooting, or administrative function. As noted above, in one or more embodiments, the additional ports are formed from at least some of the links of the switching unit that were unused for data ports.

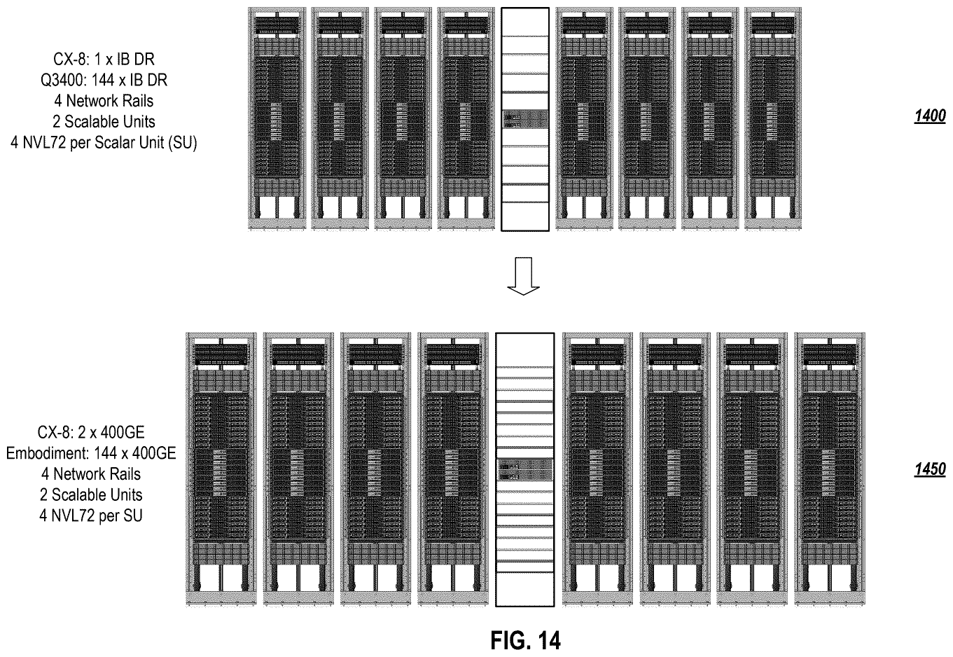

FIGS. 14-17 depict, by way of illustration and not limitation, example deployments using NVIDIA's Q3400 switch versus example deployments using a networking information handling system according to embodiments of the present disclosure.

Multiple entities, particularly those wanting to develop and/or deploy ML/AI applications, desire high-density rack-scale GPU solutions. One such system is the NVL72 system from NVIDIA. FIG. 13 depicts an example NVL72 system 1300. As previously discussed above, the NVL72 system typically comprises eighteen (18) compute sleds (or trays) 1310 and 1320 and nine (9) switches 1315 for data traffic processing—all housed within a rack 1305. The switches implement or help form an NVLink-based scale-up fabric, which is an intra-rack fabric that connects all GPUs.

The system may comprise additional elements, such as power supplies, cooling system(s), redundancy system(s), additional processing information handling system(s), among other elements common to a network or data center rack.

FIG. 14 graphically depicts an example racking configuration using NVIDIA Q3400 switches and scalar units with NVL72s versus an example racking configuration using embodiments of the present disclosure, according to embodiments of the present disclosure.

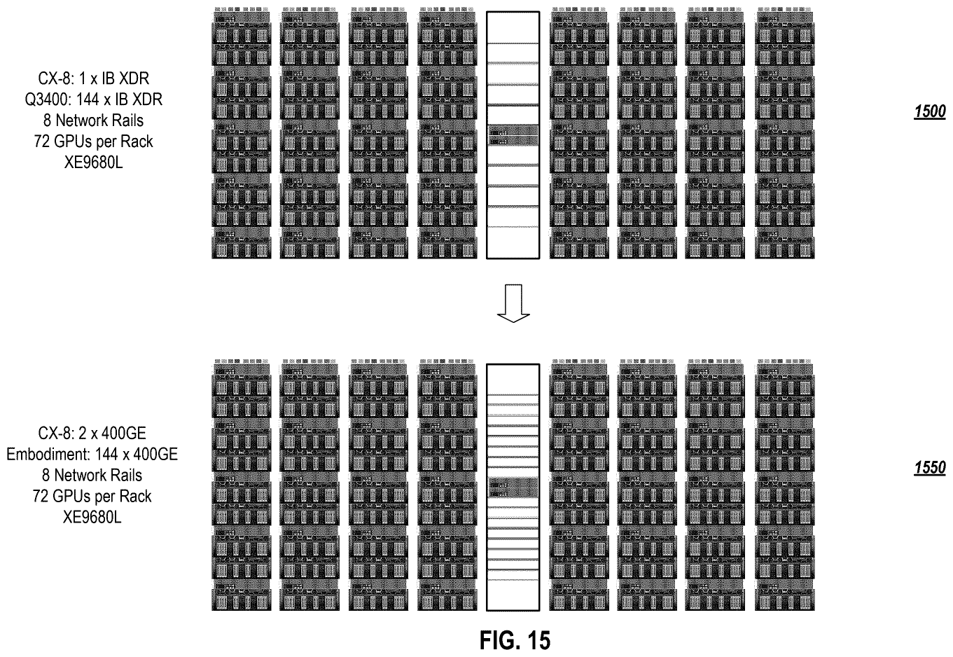

FIG. 15 graphically depicts an example racking configuration using NVIDIA Q3400 switches and scalar units with XE9680Ls having 72 GPUs per rack versus an example racking configuration using embodiments of the present disclosure, according to embodiments of the present disclosure.

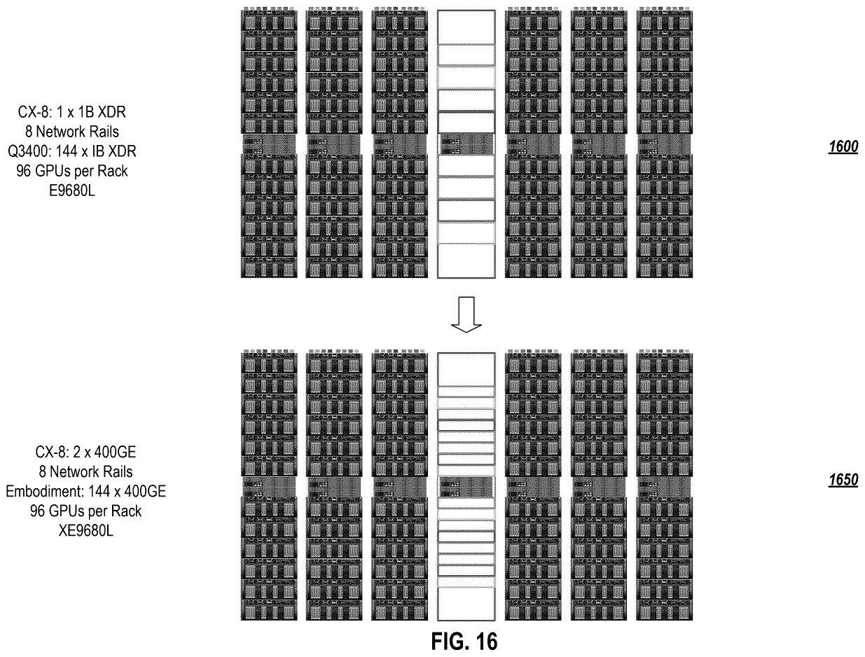

FIG. 16 graphically depicts an example racking configuration using NVIDIA Q3400switches and scalar units with XE9680Ls having 96 GPUs per rack versus an example racking configuration using embodiments of the present disclosure, according to embodiments of the present disclosure.

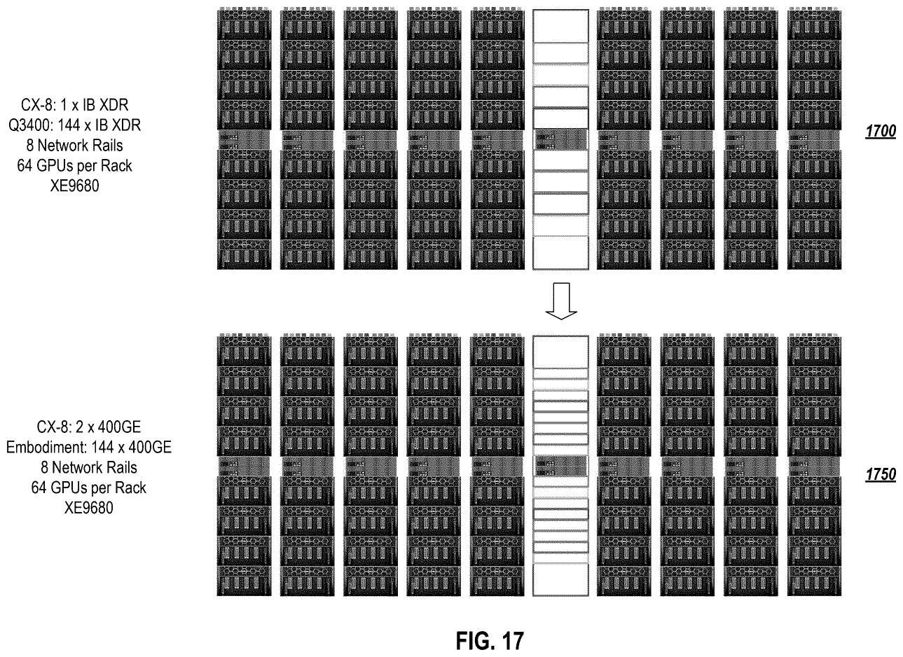

FIG. 17 graphically depicts an example racking configuration using NVIDIA Q3400switches and scalar units with XE9680s having 64 GPUs per rack versus an example racking configuration using embodiments of the present disclosure, according to embodiments of the present disclosure.

As can be seen by the comparisons, embodiments can provide Ethernet-based racking configurations that effectively and efficiently utilize rack space and the networking devices.

### C. Information Handling System (IHS) Embodiments and IHS-Related Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

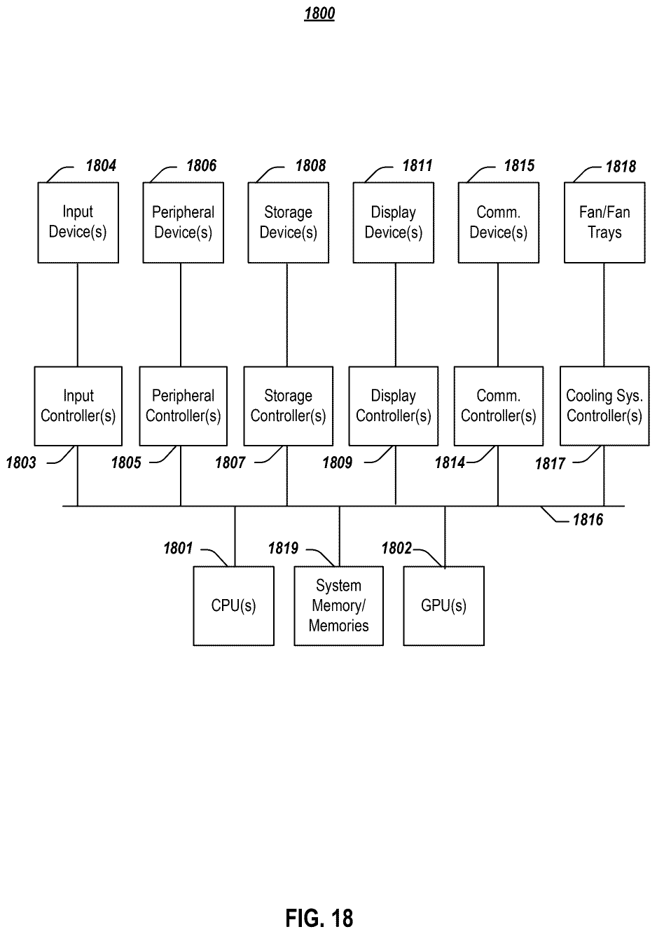

FIG. 18 depicts a simplified block diagram of an information handling system (or computing system), according to embodiments of the present disclosure. It will be understood that the functionalities shown for system 1800 may operate to support various embodiments of a computing system—although it shall be understood that a computing system may be differently configured and include different components, including having fewer or more components as depicted in FIG. 18.

As illustrated in FIG. 18, the computing system 1800 includes one or more CPUs 1801 that provides computing resources and controls the computer. CPU 1801 may be implemented with a microprocessor or the like and may also include one or more graphics processing units (GPU) 1802 and/or a floating-point coprocessor for mathematical computations. In one or more embodiments, one or more GPUs 1802 may be incorporated within the display controller 1809, such as part of a graphics card or a subcomponent. In one or more embodiments, the system may alternatively or additionally include one or more data processing units (DPUs) (not shown). In the realm of data centers and cloud computing, a DPU refers to a specialized processing unit designed to accelerate data processing tasks. DPUs are typically optimized for handling data-centric workloads such as networking, storage, security, and other tasks related to data processing and manipulation. DPUs often offload specific tasks from a main CPU, allowing for improved performance, efficiency, and scalability in data-intensive applications. They may include specialized hardware components and dedicated software to efficiently process and manage data flows within a system. The system 1800 may also include a system memory 1819, which may comprise RAM, ROM, or both.

A number of controllers and peripheral devices may also be provided, as shown in FIG. 18. An input controller 1803 represents an interface to various input device(s) 1804, such as a keyboard, mouse, touchscreen, stylus, microphone, camera, trackpad, display, etc. The computing system 1800 may also include a storage controller 1807 for interfacing with one or more storage devices 1808 each of which includes a storage medium such as magnetic tape or disk, or an optical medium that might be used to record programs of instructions for operating systems, utilities, and applications, which may include embodiments of programs that implement various aspects of the present disclosure. Storage device(s) 1808 may also be used to store processed data or data to be processed in accordance with the disclosure. The system 1800 may also include a display controller 1809 for providing an interface to a display device 1811, which may be a cathode ray tube (CRT) display, a thin film transistor (TFT) display, organic light-emitting diode, electroluminescent panel, plasma panel, or any other type of display. The computing system 1800 may also include one or more peripheral controllers or interfaces 1805 for one or more peripherals 1806. Examples of peripherals may include one or more printers, scanners, input devices, output devices, sensors, and the like. A communications controller 1814 may interface with one or more communication devices 1815, which enables the system 1800 to connect to remote devices through any of a variety of networks including the Internet, a cloud resource (e.g., an Ethernet cloud, a Fibre Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1800 comprises one or more fans or fan trays 1818 and a cooling subsystem controller or controllers 1817 that monitors thermal temperature(s) of the system 1800 (or components thereof) and operates the fans/fan trays 1818 to help regulate the temperature.

In the illustrated system, all major system components may connect to a bus 1816, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

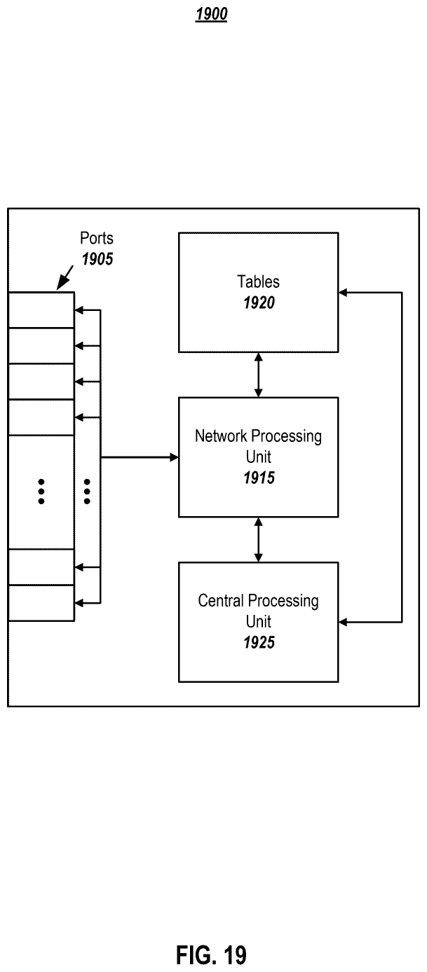

FIG. 19 depicts an alternative block diagram of an information handling system, according to embodiments of the present disclosure. It will be understood that the functionalities shown for system 1900 may operate to support various embodiments of the present disclosure—although it shall be understood that such system may be differently configured and include different components, additional components, or fewer components.

The information handling system 1900 may include a plurality of I/O ports 1905, a network processing unit (NPU) 1915, one or more tables 1920, and a CPU 1925. The system includes a power supply (not shown) and may also include other components, which are not shown for sake of simplicity.

In one or more embodiments, the I/O ports 1905 may be connected via one or more cables to one or more other network devices or clients. The network processing unit 1915 may use information included in the network data received at the node 1900, as well as information stored in the tables 1920, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable/processor-readable/information-handling-system-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art shall recognize that no computing system or programming language is critical to the practice of the present disclosure. One skilled in the art will also recognize that a number of the elements described above may be physically and/or functionally separated into modules and/or sub-modules or combined together.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claim or claims may be arranged differently including having multiple dependencies, configurations, and combinations.

What is claimed is:

1. An information handling system comprising:
a switching module comprising:
a switching unit comprising links for data handling;
a number of data ports formed from at least some of the links, in which the number of data ports of the switching module is set based upon the number having a factorization that corresponds to a factorization of a number of ports of a computing system for use with the system; and
at least some of the links of the switching unit are not used to form data ports or interfaces but are unused; and
power interface to receive power for powering the switching module.

2. The information handling system of claim 1 wherein the switching unit is a switching application-specific integrated circuit (ASIC).

3. The information handling system of claim 1 wherein the number of data ports of the switching module comprises 3 as a factor.

4. The information handling system of claim 3 wherein the number of data ports of the switching module is 144.

5. The information handling system of claim 1 wherein at least some of the links unused for data ports are used to form one or more interfaces for one or more non-data-traffic-handling functions.

6. The information handling system of claim 5 wherein the one or more non-data-traffic-handling functions comprise one or more of: in-band management, network troubleshooting, and switch port analysis.

7. The information handling system of claim 6 wherein because the switching module comprises unused links, the switching module uses less power than if all the links of the switching module were used and therefore requires less cooling.

8. The information handling system of claim 6 wherein because the switching module comprises unused links, the switching module uses less power than if all the links of the switching module were used and is housed in a smaller form factor.

9. A system for comprising:
a switching module comprising:
a switching unit comprising links for data handling; and
a number of data ports formed from at least some of the links, in which the number of data ports of the switching module is determined based upon the number having a prime factorization that corresponds to a prime factorization of a number of ports of a computing system for use with the system.

10. The system of claim 9 wherein the switching unit is a switching application-specific integrated circuit (ASIC).

11. The system of claim 9 wherein the number of data ports of the switching module comprises a factor of 3.

12. The system of claim 11 wherein the switching module comprises 144 data ports.

13. The system of claim 9 wherein at least some of the links unused for data ports are used to form one or more interfaces for one or more non-data-traffic-handling functions.

14. The system of claim 13 wherein the one or more non-data-traffic-handling functions comprise one or more of: in-band management, network troubleshooting, and switch port analysis.

15. The system of claim 9 wherein at least some of the links of the switching module are not used to form data ports or interfaces but are unused.

16. The system of claim 15 wherein because the switching module comprises unused links, the switching module uses less power than if all the links of the switching module were used and therefore requires less cooling.

17. The system of claim 15 wherein because the switching module comprises unused links, the switching module uses less power than if all the links of the switching module were used and is housed in a smaller form factor.

18. A method comprising:
given a set of compute nodes, in which a compute node comprises a number of ports, forming a network fabric to communicatively connect the set of compute nodes using networking information handling systems,
in which at least some of the networking information handling systems comprise a number of data ports having a factorization that corresponds to a factorization of the number of ports of the compute nodes and in which each of the at least some of the networking information handling systems comprises:
a switching unit comprising links for data handling, in which at least some of the links form the data ports form the number of data ports; and
power interface to receive power for powering the networking information handling system.

19. The method of claim 18 wherein at least one of the networking information handling systems comprises one or more additional interfaces and the method further comprises:
forming a communicative connection via at least one of the one or more additional interfaces for management, troubleshooting, or administrative functions, in which at least some of the links of the switching unit that were unused for data ports are used to form the one or more additional interfaces.

20. The method of claim 18 wherein at least some of the links of the switching unit are not used to form data ports or interfaces but are unused and as a result the networking information handling system requires less cooling, less space, or both.
